(19) United States
(12) Patent Application Publication
(10) Pub. No.: US 2025/0102796 A1
(43) Pub. Date: Mar. 27, 2025

(54) HEAD UP DISPLAY APPARATUS AND CONTROL METHOD OF HEAD UP DISPLAY APPARATUS

(71) Applicant: MAXELL, LTD., Kyoto (JP)

(72) Inventor: Tomoki YAMAMOTO, Kyoto (JP)

(21) Appl. No.: 18/730,022

(22) PCT Filed: Jan. 16, 2023
(86) PCT No.: PCT/JP2023/001041

§ 371 Date: Jul. 18, 2024

(30) Foreign Application Priority Data
Jan. 24, 2022 (JP) 2022-008347

(51) Int. Cl. G02B 27/01

(52) U.S. Cl. CPC G02B 27/0101; G02B 27/0149; G02B 2027/0154

(57) ABSTRACT

A head up display apparatus capable of reducing a time period during which a user cannot visually recognize a virtual image while preventing damage due to sunlight and a control method thereof are provided. According to the present invention, it is possible to contribute to “Goal 3: Ensure healthy lives and promote well-being for all at all ages” in the Sustainable Development Goals (SDGs). A video display 35 displays a video and emits video light of the displayed video. A mirror (video light projector) M1 projects the video light emitted from the video display 35 to a display region 5 so as to be reflected, thereby causing a user to visually recognize the projected video light as a virtual image. A shutter 68 is provided on an optical path 30 of the video light and switches to an optical path forming state in which the optical path of the video light is formed or an optical path non-forming state in which the optical path of the video light is not formed.

### TECHNICAL FIELD

The present invention relates to a head up display apparatus and a control method thereof, for example, a technique for a head up display apparatus using the augmented reality (AR).

### BACKGROUND ART

Patent Document 1 discloses a head up display apparatus capable of effectively preventing the intrusion of external light such as sunlight. The head up display apparatus includes a shutter unit having a plurality of shutters, and prevents the intrusion of external light and thus damage to a display by changing the size of a transmission window formed in the shutter unit in accordance with the size of a display image displayed on the display.

### RELATED ART DOCUMENTS

### Patent Documents

Patent Document 1: Japanese Unexamined Patent Application Publication No. 2015-152746

### SUMMARY OF THE INVENTION

### Problems to be Solved by the Invention

For example, a head up display (abbreviated as “HUD” in this specification) is installed in some cases in transportations typified by vehicles such as automobiles. The HUD displays driving information such as vehicle speed and engine speed, navigation information, and others by projecting them onto a windshield (front glass) or the like. By using the HUD, the driver can obtain the information necessary for driving without moving the line of sight to the instrument panel incorporated in the dashboard. Therefore, it is possible to contribute to safe driving.

On the other hand, the use of AR for displaying various information added to objects on the actually existing landscape has been desired in HUDs in recent years. In particular, a wide display region is required in an HUD using AR (referred to as an AR-HUD). In order to widen the display region, it is necessary to widen the opening provided on the optical path of the video light, that is, on the optical path from the display panel to the windshield. However, as the opening becomes wider, sunlight is more likely to enter through an optical path in a direction opposite to the optical path of the video light. As a result, the display panel is damaged more often.

In view of this, a method of changing the size of the transmission window as disclosed in Patent Document 1 is conceivable. However, even in the case where the size of the transmission window is changed in accordance with the size of the display image, since there may still be a spot at which sunlight is concentrated on the display panel, sufficient protection cannot always be achieved. In order to achieve sufficient protection, for example, it is desirable to block the optical path through which sunlight enters. However, when the optical path of sunlight is blocked, normally, the optical path of the video light from the display panel is also blocked at the same time, so that there will be a time period during which the user cannot visually recognize the virtual image.

The present invention has been made in view of the above, and one object thereof is to provide a head up display apparatus capable of reducing the time period during which the user cannot visually recognize the virtual image while preventing the damage due to sunlight and a control method thereof.

The above and other objects and novel features of the present invention will become apparent from the description of this specification and accompanying drawings.

### Means for Solving the Problems

An outline of the typical invention disclosed in this application will be briefly described as follows.

A typical head up display apparatus is a head up display apparatus for a transportation and includes a video display, a video light projector, and a switching unit. The video display emits video light of a video. The video light projector projects the video light emitted from the video display to a display region so as to be reflected, thereby displaying a virtual image in front of the transportation. The switching unit is provided on an optical path of the video light and switches to an optical path forming state in which the optical path of the video light is formed or an optical path non-forming state in which the optical path of the video light is not formed.

### Effect of the Invention

An effect achieved by a typical invention disclosed in this application will be briefly described as follows. Namely, it is possible to reduce the time period during which the user cannot visually recognize the virtual image while preventing the damage due to sunlight in a head up display apparatus.

### BRIEF DESCRIPTIONS OF THE DRAWINGS

FIG. 1 is a schematic diagram showing a configuration example of a vehicle in which a head up display apparatus according to the first embodiment is installed.

FIG. 2 is a schematic diagram showing a configuration example of a main part of the HUD apparatus in FIG. 1.

FIG. 3 is a diagram showing a more detailed configuration example and operation example of the HUD apparatus in FIG. 2.

FIG. 4 is a perspective view showing an example of an outer shape of the HUD apparatus shown in FIG. 3.

FIG. 5 is a block diagram showing a configuration example of a main part of a control system in the HUD apparatus shown in FIG. 3.

FIG. 6 is a block diagram showing a configuration example of a part related to an information acquisition unit in FIG. 5.

FIG. 7A is a diagram for describing an example of process contents of a temperature detector in FIG. 5.

FIG. 7B is a diagram for describing an example of process contents of the temperature detector in FIG. 5.

FIG. 8 is a time chart showing an example of a control method of a light source in FIG. 3.

FIG. 9 is a time chart showing an example of a control method of a shutter in FIG. 3.

FIG. 10A is a diagram for describing a specific application example of the shutter in FIG. 3 and an operation example at that time.

FIG. 10B is a diagram for describing a specific application example of the shutter in FIG. 3 and an operation example at that time.

FIG. 11 is a time chart showing an example of a relationship between a control method of the light source and the shutter in FIG. 3 and sunlight intensity.

FIG. 12 is a flow diagram showing an example of process contents of a controller related to the control of the shutter in FIG. 5.

FIG. 13 is a diagram showing a specific example of a condition judgment (step S100) shown in FIG. 12.

FIG. 14 is a supplementary diagram for FIG. 13 and is a diagram showing an example of a positional relationship between the sun and a vehicle.

FIG. 15A is a diagram for describing another specific application example of the shutter in FIG. 3 and an operation example at that time.

FIG. 15B is a diagram for describing another specific application example of the shutter in FIG. 3 and an operation example at that time.

FIG. 16A is a diagram for describing still another specific application example of the shutter in FIG. 3 and an operation example at that time.

FIG. 16B is a diagram for describing still another specific application example of the shutter in FIG. 3 and an operation example at that time.

FIG. 17A is a diagram for describing a specific application example of a shutter in an HUD apparatus according to the second embodiment and an operation example at that time.

FIG. 17B is a diagram for describing a specific application example of the shutter in the HUD apparatus according to the second embodiment and an operation example at that time.

### DETAILED DESCRIPTION OF PREFERRED EMBODIMENTS

Hereinafter, embodiments of the present invention will be described in detail with reference to the drawings. In all the drawings for describing the embodiments, the same members are denoted by the same reference characters in principle, and the repetitive description thereof will be omitted.

### First Embodiment

### <Outline of HUD Apparatus>

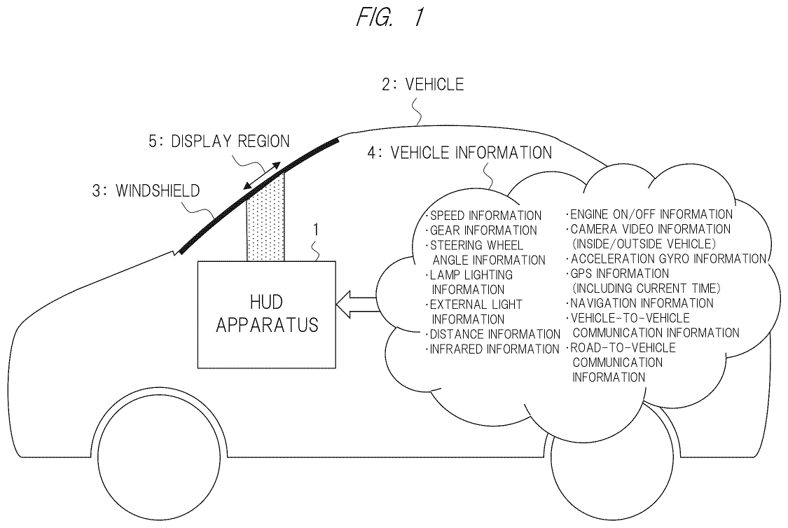

FIG. 1 is a schematic diagram showing a configuration example of a vehicle in which a head up display apparatus according to the first embodiment is installed. A head up display (HUD) apparatus 1 shown in FIG. 1 is installed in a vehicle 2 as an example of transportation. The vehicle 2 is typically an automobile, but is not always limited to this and may be a train car or the like. Also, the transportation is not limited to a vehicle and may be an airplane or the like. Further, a control unit (not shown) referred to as an ECU (Electronic Control Unit) is usually installed in the vehicle 2.

The control unit acquires vehicle information 4 from, for example, various sensors installed in each part of the vehicle 2 and also from a navigation device or the like. The various sensors detect, for example, various events occurring in the vehicle 2 and also detect various parameter values related to the driving situation. The HUD apparatus 1 acquires the vehicle information 4 acquired by the control unit through, for example, the CAN (Controller Area Network) communication.

The vehicle information 4 includes, for example, speed information and gear information of the vehicle 2, steering wheel angle information, lamp lighting information, external light information, distance information, infrared information, engine ON/OFF information, camera video information inside and outside the vehicle, acceleration gyro information, GPS (Global Positioning System) information, navigation information, vehicle-to-vehicle communication information, road-to-vehicle communication information, and others. The GPS information further includes information such as the current time. The HUD apparatus 1 projects a video onto a display region 5 such as a windshield 3 based on the vehicle information 4. In this way, the HUD apparatus 1 causes a user such as a driver to visually recognize the video projected on the display region 5 as a virtual image, more specifically, as a virtual image superimposed on the landscape in front of the vehicle 2.

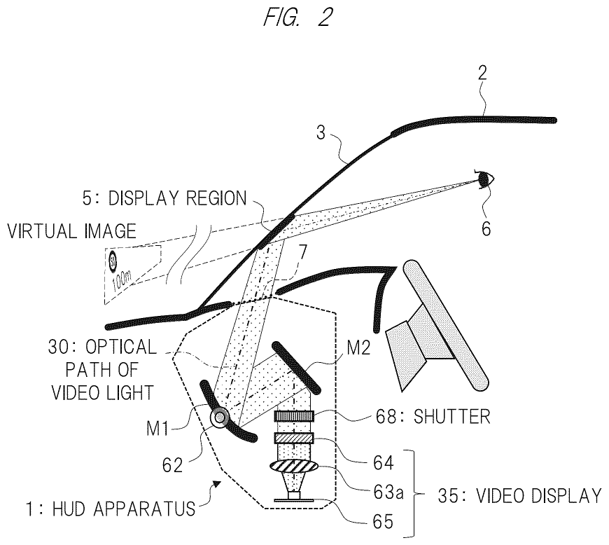

FIG. 2 is a schematic diagram showing a configuration example of a main part of the HUD apparatus in FIG. 1. The HUD apparatus 1 shown in FIG. 2 includes a video display 35, mirrors M1 and M2 that are light reflecting members, and a switching unit, for example, a shutter 68. The video display 35 is, for example, a projector, a liquid crystal display (LCD), or the like, and displays a video based on input video data and generates and emits video light of the displayed video. The video display 35 specifically includes a light source 65, an optical element 63a, and a display panel 64.

The light source 65 is, for example, an LED (Light Emitting Diode) light source, a laser light source, or the like, and irradiates the display panel 64 with backlight. Specifically, the light source 65 turns on the backlight when it is controlled on, and turns off the backlight when it is controlled off. The optical element 63a is, for example, a lens for light source, and adjusts the optical path of the backlight such that the display panel 64 is evenly irradiated with the backlight from the light source 65. The display panel 64 is typically a liquid crystal panel (LCD: Liquid Crystal Display). The display panel 64 displays a video by modulating the backlight from the light source 65, more specifically, by modulating transmittance in each pixel, in accordance with the input video data.

The mirror M2 is, for example, a plane mirror, and is provided on an optical path 30 of the video light between the video display 35 and the mirror M1. The mirror M2 functions as a video light reflector configured to reflect the video light from the video display 35 to the mirror M1. The mirror M1 is, for example, a concave mirror (magnifying mirror), and is provided on the optical path 30 of the video light between the mirror M2 and the display region 5. The mirror M1 functions as a video light projector configured to project the video light emitted from the video display 35 onto the display region 5, thereby causing a user such as a driver 6 to visually recognize the projected video light as a virtual image. In other words, the video light projector projects the video light emitted from the video display 35 onto the display region 5 of the transportation so as to be reflected, thereby displaying a virtual image in front of the transportation.

More specifically, the mirror (video light projector) M1 reflects and magnifies the video light reflected by the mirror (video light reflector) M2, and projects it onto the display region 5 through an opening 7. The video light projected onto the display region 5 is reflected by the display region 5 and enters the eyes of the driver 6. As a result, the driver 6 visually recognizes the video light projected on the display region 5 as a virtual image beyond the transparent windshield 3 in a form of being superimposed on the landscape (roads, buildings, people, etc.) outside the vehicle. The information represented by the virtual image includes, for example, road signs, the current speed of the own vehicle, and various information added to objects on the landscape, that is, AR information.

Note that the mirror M1 and the mirror M2 may be, for example, a free-form surface mirror or a mirror having a shape asymmetrical with respect to an optical axis. Here, the installation angle of the mirror (video light reflector) M2 is fixed. On the other hand, the mirror (video light projector) M1 includes a drive mechanism 62. In this way, the installation angle of the mirror M1 is variably adjusted via the drive mechanism 62. The drive mechanism 62 includes, for example, a motor and rotates the mirror M1 by the rotating operation of the motor. By adjusting the angle of the mirror M1 while rotating it around the rotation axis, it is possible to switch to a projection mode in which the video light is projected onto the display region 5 or a non-projection mode in which the video light is not projected onto the display region 5.

In addition, by adjusting the installation angle of the mirror M1 in the projection mode, it is possible to adjust the position of the display region 5 on the windshield 3, that is, the position of the virtual image in the vertical direction visually recognized by the driver 6. Further, for example, by increasing the area of the mirror M1 and the opening 7, the area of the display region 5 can be expanded, and more information can be projected onto the display region 5. In this way it is possible to realize the AR function to display various information added to objects on the landscape.

The shutter 68 is provided on the optical path 30 of the video light, more specifically, on the optical path 30 of the video light between the video display 35 and the mirror (video light reflector) M2 in the example shown in FIG. 2. The shutter 68 is controlled to an optical path forming state in which the optical path of the video light is formed or an optical path non-forming state in which the optical path of the video light is not formed. In the example shown in FIG. 2, the shutter 68 transmits the light in the optical path forming state and blocks the light in the optical path non-forming state. The shutter 68 is typically a liquid crystal shutter or the like capable of quickly switching between the light transmission state and the light blocking state. Though details thereof will be described later, the switching between the optical path forming state and the optical path non-forming state is performed at a speed high enough for the driver 6 to be able to visually recognize the video light projected on the display region 5 as a virtual image.

### <Details of HUD Apparatus>

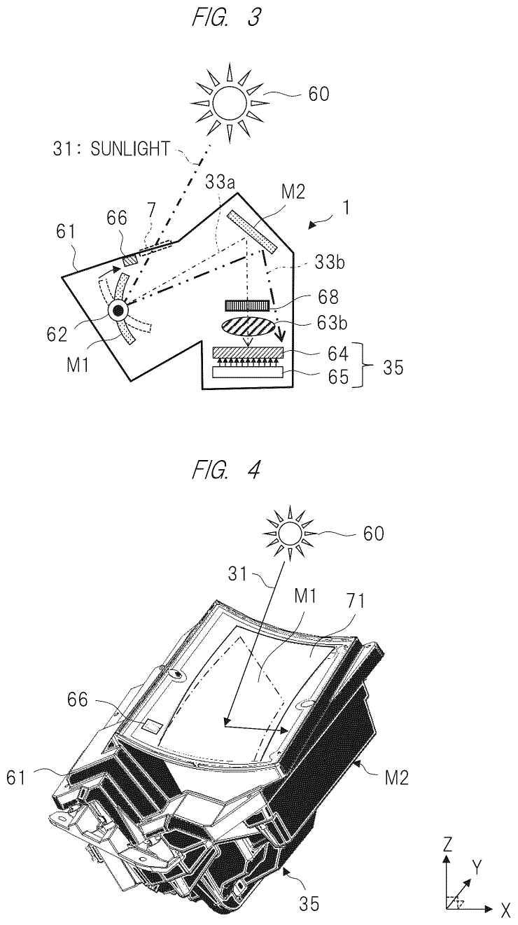

FIG. 3 is a diagram showing a more detailed configuration example and operation example of the HUD apparatus in FIG. 2. FIG. 4 is a perspective view showing an example of an outer shape of the HUD apparatus shown in FIG. 3. The HUD apparatus 1 shown in FIG. 3 includes the video display 35, the shutter 68, the mirrors M1 and M2, and the drive mechanism 62 similar to those of the case in FIG. 2 in a housing 61. The HUD apparatus 1 shown in FIG. 3 further includes an insolation sensor 66 and an optical element 63b in the housing 61.

The insolation sensor 66 detects the position of the sun 60 and the intensity of the sunlight 31. The optical element 63b is a projection lens, and is provided on the optical path of the video light between the video display 35 and the shutter 68. For example, the optical element 63b adjusts the spread of the video light from the display panel 64. In FIG. 3, for the sake of simplicity, illustration of the optical element 63a in the video display 35 shown in FIG. 2 is omitted.

Here, the mirror (video light projector) M1 is controlled to the projection mode in which the video light is projected onto the display region or a non-projection mode in which the video light is not projected onto the display region, by adjusting the installation angle via the drive mechanism 62. The direction of the arrow shown in FIG. 3 is the direction in which the mirror M1 rotates and is the direction of switching from the projection mode to the non-projection mode. In the projection mode, the video light is projected onto the display region, whereas the sunlight 31 may enter the display panel 64 along an optical path 33a in the direction opposite to the optical path of the video light. As a result, the display panel 64 may be damaged. Thus, by controlling the mirror M1 to the non-projection mode, an optical path 33b can be formed such that the sunlight 31 does not enter the display panel 64.

Note that, since the shutter 68 is provided in FIG. 3, even if the mirror M1 is controlled to the projection mode, it is possible to prevent the sunlight 31 from entering the display panel 64 by fixing the shutter to the optical path non-forming state, for example, to a light blocking state. However, depending on the material and others, the shutter 68 may deteriorate due to the exposure to strong sunlight 31. For this reason, it is desirable to provide the non-projection mode and adjust the installation angle of the mirror M1 so as to form the optical path 33b away from the shutter 68.

Whether or not to control the mirror (video light projector) M1 to the non-projection mode can be judged based on, for example, the detection result of the insolation sensor 66. Although not shown, a temperature sensor for detecting the ambient temperature may also be installed in the housing 61. Then, whether or not to control the mirror M1 to the non-projection mode may be judged based on the ambient temperature. However, for example, in the case of acquiring the ambient temperature from a temperature sensor installed in the vehicle 2, there is no need to install the temperature sensor in the housing 61.

In FIG. 4, the opening 7 shown in FIG. 3 is formed in the housing 61, and a transparent cover member 71 referred to as a glare trap or the like is attached to the opening 7. As shown in FIG. 3, the mirror (video light projector) M1 is installed in the housing 61 so as to reflect the light from the mirror (video light reflector) M2 to the cover member 71, that is, the opening 7. In addition, the insolation sensor 66 is installed in the housing 61, for example, near the cover member 71.

The insolation sensor 66 may be configured and arranged to detect the intensity of sunlight when the position (azimuth and elevation angle) of the sun 60 is within a predetermined range. For example, since the optical path of the sunlight 31 may deviate from the display panel 64 depending on the incident angle of the sunlight 31 to the mirror M1 and thus the position of the sun 60, the possibility of damage to the display panel 64 can be ignored. Namely, depending on the season, time of day, orientation of the vehicle 2, and others, the possibility of damage can be ignored.

The range of incident angle in which the possibility of damage can be ignored, in other words, the range of incident angle in which the possibility of damage cannot be ignored, can be determined in advance based on the optical conditions (for example, installation position, installation angle, size, and the like) of the optical system including the mirrors M1 and M2 and the optical element 63b. Therefore, the insolation sensor 66 detects the intensity of sunlight within a predetermined range, which is the range of incident angle (position of the sun 60) in which the possibility of damage to the display panel 64 cannot be ignored.

As a specific configuration of the insolation sensor 66, for example, a configuration in which an opening, a shielding plate, and the like are provided as appropriate around a light receiving element such as a photodiode to physically limit the incident angle of sunlight entering the light receiving element can be presented. Alternatively, a configuration in which a known insolation sensor capable of detecting both the position of the sun 60 and the intensity of sunlight (for example, a sensor configured to detect the position based on the balance of light intensity of four light receiving elements) is provided to perform signal processing based on the detected position information and sunlight intensity information in combination is also possible. Note that the insolation sensor 66 does not necessarily need to detect the position of the sun 60 as long as it is configured and arranged to detect at least the intensity of sunlight.

### <Configuration of Control System of HUD Apparatus>

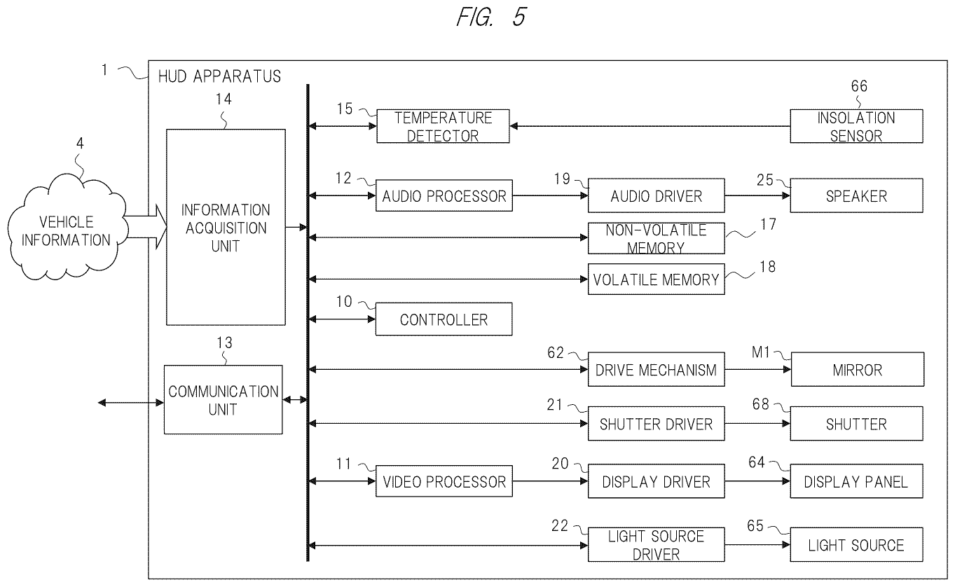

FIG. 5 is a block diagram showing a configuration example of a main part of a control system in the HUD apparatus shown in FIG. 3. The HUD apparatus 1 shown in FIG. 5 includes a controller 10, a video processor 11, an audio processor 12, a communication unit 13, an information acquisition unit 14, a temperature detector 15, a non-volatile memory 17, a volatile memory 18, a shutter driver 21, a light source driver 22, and a drive mechanism 62, which are connected to each other by a bus. The HUD apparatus 1 further includes an audio driver 19, a display driver 20, a speaker 25, the display panel 64, the light source 65, the insolation sensor 66, the shutter 68, and the mirror (video light projector) M1.

Various programs and various data are stored in the non-volatile memory 17. The various programs and various data stored in the non-volatile memory 17 are copied to the volatile memory 18 as appropriate and are referenced by the processor. The information acquisition unit 14 is configured of, for example, a CAN interface circuit or a LIN (Local Interconnect Network) interface circuit, and acquires the vehicle information 4 from the control unit by means of the CAN communication or LIN communication as described with reference to FIG. 1. The communication unit 13 is configured of, for example, a wired communication interface circuit or a wireless communication interface circuit based on a predetermined communication standard, and communicates various types of control information other than the vehicle information 4 with the outside of the HUD apparatus 1.

The light source driver 22 is configured of, for example, an LED driver circuit, and drives the light source 65. As an example thereof, the light source driver 22 controls the luminance of the backlight from the light source 65 by periodically switching between application and non-application of a voltage to the light source 65. Specifically, the light source driver 22 controls the luminance of the backlight by means of, for example, PWM (Pulse Width Modulation) control.

The video processor 11 generates video data that determines the video to be displayed on the display panel 64 and thus the video to be projected on the display region 5 shown in FIG. 2, based on the vehicle information 4 and the like. At this time, the video processor 11 generates video data subjected to the correction of various distortions that may occur due to, for example, the curvature of the windshield 3. The video processor 11 is realized by, for example, the processor executing a video processing program stored in the volatile memory 18.

The display driver 20 is configured of, for example, an LCD driver circuit. The display driver 20 drives each display element (pixel) included in the display panel 64 based on the video data from the video processor 11. In this way, the display driver 20 causes the display panel 64 to display the video based on the video data by modulating the backlight from the light source 65.

The audio processor 12 generates audio data based on the vehicle information 4 and the like as necessary. The audio data is generated, for example, when providing audio guidance from a navigation device, when issuing a warning to the driver 6 by AR function, and the like. The audio driver 19 causes the speaker 25 to output audio by driving the speaker 25 based on the audio data from the audio processor 12. The audio processor 12 is realized by, for example, the processor executing an audio processing program stored in the volatile memory 18.

The shutter driver 21 is configured of, for example, a driver circuit in accordance with the type of the shutter 68. As described with reference to FIG. 2, the shutter driver 21 controls the shutter 68 to the optical path forming state or the optical path non-forming state. The drive mechanism 62 is configured of, for example, a motor and a motor driver circuit configured to drive the motor. The drive mechanism 62 adjusts the installation angle of the mirror M1.

The temperature detector 15 detects the temperature of the video display 35, specifically, the temperature of the display panel 64. At this time, though details will be described later, the temperature detector 15 estimates the temperature of the display panel 64 by calculation based on the detection result from the insolation sensor 66, that is, the intensity of sunlight and the like. Namely, it is difficult to directly detect the temperature of the display panel 64 in some cases due to mounting restrictions and the like. The temperature detector 15 is provided in such a case, and indirectly detects the temperature of the display panel 64 by a predetermined calculation. The temperature detector 15 is realized by, for example, the processor executing a temperature detection program stored in the volatile memory 18.

The controller 10 controls the entire HUD apparatus 1. As an example thereof, the controller 10 controls the luminance of the backlight from the light source 65 via the light source driver 22. Namely, the controller 10 controls the ON/OFF of the light source 65, that is, application and non-application of a voltage to the light source 65 by PWM control or the like. Furthermore, the controller 10 controls the shutter 68 via the shutter driver 21 so as to periodically switch between the optical path forming state and the optical path non-forming state. The controller 10 is realized by, for example, the processor executing a control program stored in the volatile memory 18.

Note that the controller 10, the video processor 11, the audio processor 12, the communication unit 13, the information acquisition unit 14, the temperature detector 15, the non-volatile memory 17, and the volatile memory 18 may be realized by a microcontroller or the like provided with a processor and various peripheral circuits. However, some or all of these may be realized as appropriate by FPGA (Field Programmable Gate Array), ASIC (Application Specific Integrated Circuit), or the like.

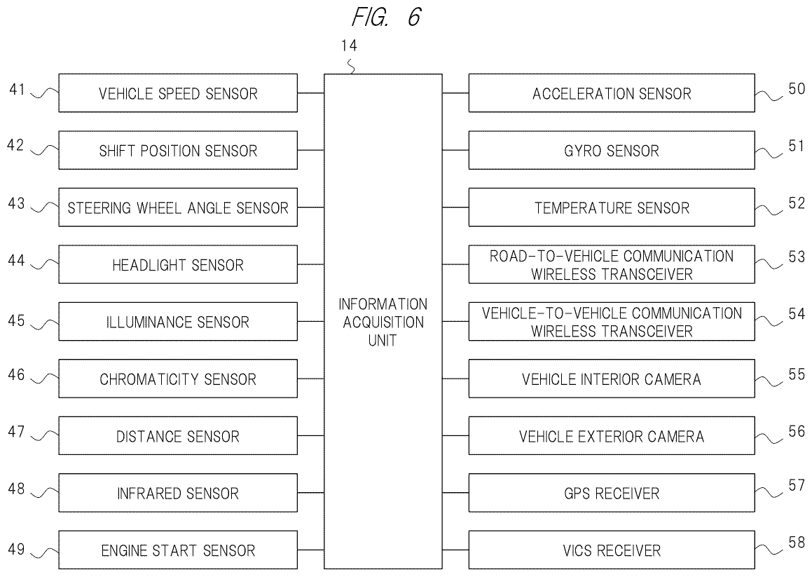

FIG. 6 is a block diagram showing a configuration example of a part related to the information acquisition unit in FIG. 5. The information acquisition unit 14 acquires the vehicle information 4 generated by information acquisition devices such as various sensors via a control unit (not shown). FIG. 6 shows an example of the information acquisition device.

In FIG. 6, a vehicle speed sensor 41 detects the speed of the vehicle 2 in FIG. 1 and generates speed information as a detection result. A shift position sensor 42 detects the current gear and generates gear information as a detection result. A steering wheel angle sensor 43 detects a current steering wheel angle and generates steering wheel angle information as a detection result. A headlight sensor 44 detects ON/OFF of the headlight and generates lamp lighting information as a detection result. An illuminance sensor 45 and a chromaticity sensor 46 detect external light and generate external light information as a detection result.

A distance sensor 47 detects the distance between the vehicle 2 and an external object and generates distance information as a detection result. An infrared sensor 48 detects the presence or absence of an object at a short distance of the vehicle 2, the distance of the object, and the like, and generates infrared information as a detection result. An engine start sensor 49 detects ON/OFF of the engine and generates ON/OFF information as a detection result. An acceleration sensor 50 and a gyro sensor 51 detect the acceleration and angular velocity of the vehicle 2, respectively, and generate acceleration gyro information representing the attitude and behavior of the vehicle 2 as a detection result. A temperature sensor 52 detects the temperature inside and outside the vehicle and generates temperature information as a detection result.

A road-to-vehicle communication wireless transceiver 53 generates road-to-vehicle communication information through road-to-vehicle communication between the vehicle 2 and roads, signs, traffic lights, and the like. A vehicle-to-vehicle communication wireless transceiver 54 generates vehicle-to-vehicle communication information through vehicle-to-vehicle communication between the vehicle 2 and other vehicles in the vicinity. A vehicle interior camera 55 and a vehicle exterior camera 56 capture images of the interior and exterior of the vehicle, respectively, and generate vehicle interior camera video information and vehicle exterior camera video information. The vehicle interior camera 55 is, for example, a DMS (Driver Monitoring System) camera that captures the posture, the eye position, and the eye movement of the driver 6 shown in FIG. 2. In this case, by analyzing the captured video, it is possible to grasp the fatigue state, the position of the line of sight of the driver 6, and the like.

On the other hand, for example, the vehicle exterior camera 56 captures the surrounding conditions such as the front and rear of the vehicle 2. In this case, by analyzing the captured video, it is possible to grasp the presence or absence of obstacles such as other vehicles and people existing in the surroundings, buildings and topography, road conditions such as rain, snow, ice, and undulations, road signs, and the like. In addition, the vehicle exterior camera 56 includes, for example, a drive recorder configured to record a video of the driving situation.

A GPS receiver 57 generates GPS information obtained by receiving GPS signals. For example, the GPS receiver 57 can acquire the current time. A VICS (Vehicle Information and Communication System, registered trademark) receiver 58 generates VICS information obtained by receiving VICS signals. The GPS receiver 57 and the VICS receiver 58 may be provided as a part of a navigation device. Note that the various information acquisition devices shown in FIG. 6 may be deleted or replaced with other types of devices or other types of devices may be added as appropriate.

### <Temperature Detector and Measures Against Sunlight>

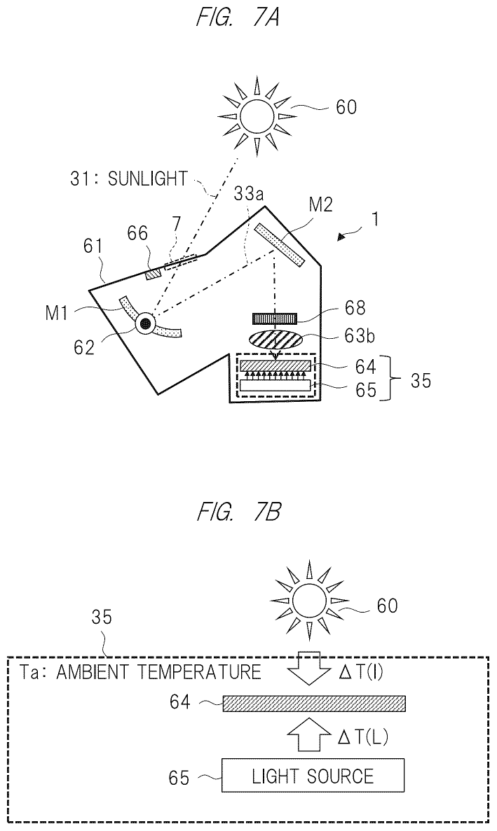

FIG. 7A and FIG. 7B are diagrams for describing an example of process contents of the temperature detector in FIG. 5. FIG. 7A shows the HUD apparatus 1 similar to that in FIG. 3. FIG. 7B shows a part of the video display 35 in FIG. 7A. As shown in FIG. 7B, the temperature of the display panel 64 can be estimated from the ambient temperature Ta of the video display 35, the temperature rise ΔT(I) due to the sunlight 31, and the temperature rise ΔT(L) due to heat radiation from the light source 65.

The ambient temperature Ta is detected by the temperature sensor installed in the HUD apparatus 1 or the temperature sensor 52 installed in the vehicle 2 as described with reference to FIG. 3. The temperature rise ΔT(I) due to the sunlight 31 is calculated based on the intensity of sunlight detected by the insolation sensor 66. The temperature rise ΔT(L) due to the heat radiation from the light source 65 is calculated based on the backlight luminance set in the light source 65, that is, the duty ratio of the PWM control, and the like. The temperature detector 15 indirectly detects the temperature of the display panel 64 by the calculation using the ambient temperature Ta, the temperature rise ΔT(I), and the temperature rise ΔT(L).

Here, the temperature rise ΔT(L) due to the heat radiation from the light source 65 is a parameter that can be controlled by the luminance of the backlight. For this reason, for example, when the temperature of the display panel 64 detected by the temperature detector 15 exceeds a predetermined threshold value, the controller 10 can suppress the temperature rise in the display panel 64 by reducing the luminance of the backlight, that is, by reducing the duty ratio of the PWM control.

On the other hand, for example, when the temperature rise ΔT(I) due to the sunlight 31 is very large, it may be difficult to suppress the temperature rise in the display panel 64 even if such backlight luminance control is used. In such a case, the controller 10 desirably controls the mirror (video light projector) M1 to the non-projection mode via the drive mechanism 62. However, when the mirror M1 is controlled to the non-projection mode, the driver 6 cannot visually recognize the virtual image. Therefore, it is beneficial to perform the control described below by using the shutter 68.

### <Details of Shutter>

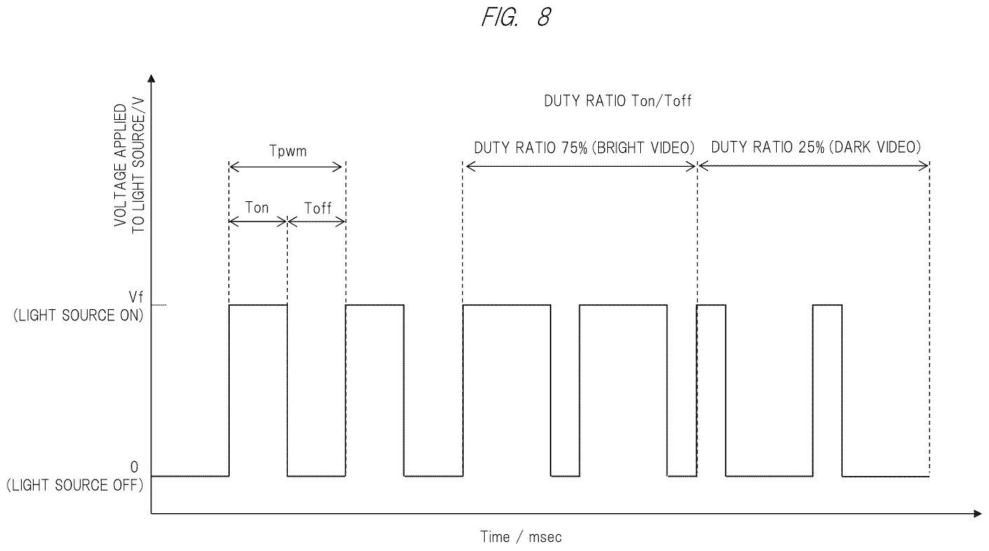

FIG. 8 is a time chart showing an example of a control method of the light source in FIG. 3. As described with reference to FIG. 7B, the controller 10 can control the luminance of the backlight in order to suppress the temperature rise ΔT(L) due to the heat radiation from the light source 65. Further, the controller 10 may control the luminance of the backlight in response to a request from the driver 6, for example, an operation by the driver 6.

In such a case, the controller 10 controls the ON/OFF of the light source 65 by using, for example, PWM control shown in FIG. 8 via the light source driver 22. Each PWM cycle Tpwm includes an ON-period Ton during which a voltage Vf is applied to the light source 65 and an OFF-period Toff during which no voltage is applied to the light source 65. The light source 65 is turned on during the ON-period Ton and turned off during the OFF-period Toff. The ratio of the ON-period Ton to the PWM cycle Tpwm (=Ton/Tpwm) is referred to as the duty ratio [%]. The video light becomes brighter as the duty ratio approaches 100%, and becomes darker as the duty ratio approaches 0%.

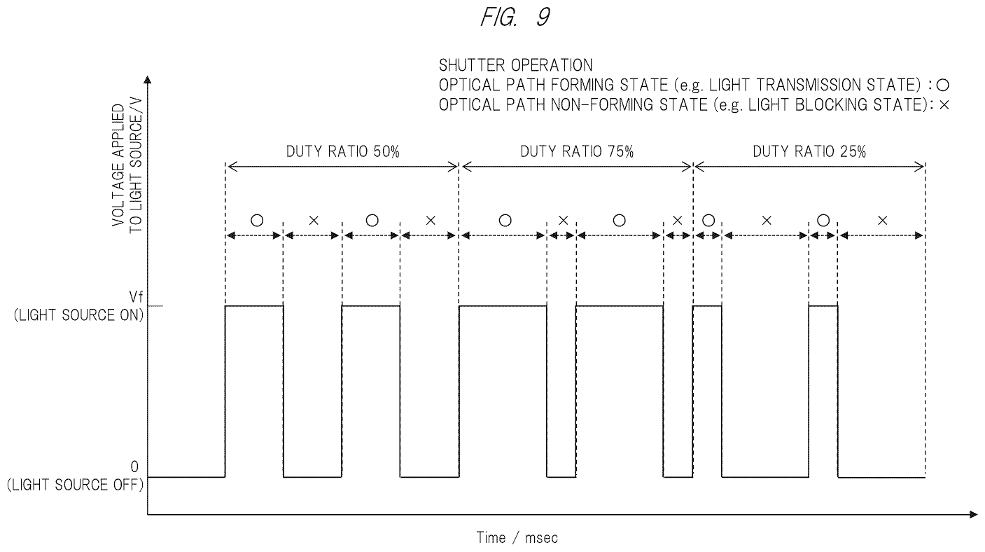

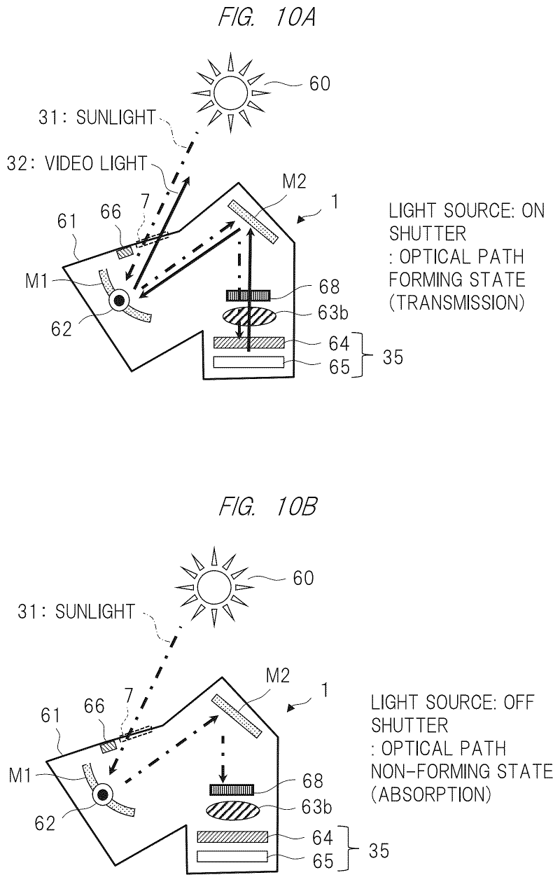

FIG. 9 is a time chart showing an example of a control method of the shutter in FIG. 3. FIG. 10A and FIG. 10B are diagrams for describing a specific application example of the shutter in FIG. 3 and an operation example at that time. As shown in FIG. 9, the controller 10 controls the shutter 68 to the optical path forming state, for example, the light transmission state during the ON-period Ton when the voltage Vf is applied to the light source 65, and the controller 10 controls the shutter 68 to the optical path non-forming state, for example, the light blocking state during the OFF-period Toff when no voltage is applied to the light source 65. In detail, the controller 10 controls the light transmission/blocking by the shutter 68 via the shutter driver 21.

FIG. 10A and FIG. 10B show the operation in the projection mode in which video light 32 is projected onto the display region. As a specific example, the shutter 68 shown in FIG. 10A and FIG. 10B is, for example, a transmission/absorption liquid crystal shutter. As shown in FIG. 10A, during the ON-period Ton of the light source 65, the shutter 68 is controlled to the optical path forming state to transmit light. Namely, the video light 32 from the video display 35 passes through the shutter 68 and enters the mirror M2. Moreover, the sunlight 31 from the mirror M2 passes through the shutter 68 and enters the video display 35. On the other hand, as shown in FIG. 10B, during the OFF-period Toff of the light source 65, the shutter 68 is controlled to the optical path non-forming state to absorb light. Namely, the shutter 68 blocks the sunlight 31 from reaching the display panel 64 by absorbing the sunlight 31.

When a liquid crystal shutter is used, the shutter 68 itself may heat up due to the absorption of the sunlight 31. In order to prevent the resultant damage to the shutter 68, for example, it is desirable that the controller 10 performs temperature management of the shutter 68 in addition to the display panel 64. As a specific example, the controller 10 can estimate the temperature of the shutter 68 based on, for example, the sunlight intensity detected by the insolation sensor 66, the duty ratio when the shutter 68 is PWM controlled, the ambient temperature Ta, and the like. Then, when the estimated temperature of the shutter 68 exceeds the threshold value, the controller 10 controls the mirror M1 to the non-projection mode, thereby preventing the shutter 68 from being damaged.

Further, the installation position of the shutter 68 is not limited to the position on the optical path of the video light 32 between the optical element 63b and the mirror (video light reflector) M2 shown in FIG. 10A and FIG. 10B. For example, the installation position of the shutter 68 may be on the optical path of the video light 32 between the video display 35 and the optical element 63b or between the mirror (video light reflector) M2 and the mirror (video light projector) M1. In this case, the shutter 68 may be installed so as to be in contact with the reflection surface of the mirror M2. Alternatively, the installation position of the shutter 68 may be on the optical path of the video light 32 between the mirror (video light projector) M1 and the display region 5, for example, at the position of the opening 7.

However, since the video light 32 may become wider as it approaches the opening 7, the required area of the shutter 68 may also become larger accordingly. Furthermore, when the installation position of the shutter 68 is too close to the display panel 64, the heat released from the shutter 68 that has absorbed the sunlight 31 may cause the temperature rise of the display panel 64. From the viewpoint of balancing these two points, it is desirable to install the shutter 68 at the position shown in FIG. 10A and FIG. 10B.

Here, the length of the PWM cycle Tpwm shown in FIG. 8 is not particularly limited, but is, for example, on the order of ms. When the PWM cycle Tpwm like this is used, the driver 6 can continuously visually recognize the virtual image by an afterimage of the virtual image projected during the ON-period Ton in spite of the presence of the OFF-period Toff. In the embodiment, the PWM control is used as a method for controlling the shutter 68, but it is not essential to use the PWM control. Namely, as an essential condition, the length of the period during which the shutter 68 is controlled to the optical path non-forming state, here, the length of the OFF-period Toff needs to be set to the length in which the driver 6 can continuously visually recognize the video light 32 as a virtual image.

In this specification, the control mode in which the shutter 68 is controlled so as to periodically switch between the optical path forming state and the optical path non-forming state as shown in FIG. 9 is referred to as a switching control mode or a first control mode. As a typical example of the switching control mode, the controller 10 controls the shutter 68 to the optical path forming state and the optical path non-forming state in conjunction with the ON/OFF of the light source 65 as shown in FIG. 9.

On the other hand, in this specification, the control mode in which the shutter 68 is fixed to the optical path forming state, for example, fixed to the light transmission state regardless of the ON/OFF of the light source 65 unlike the case of FIG. 9 is referred to as an optical path forming control mode or a second control mode. Similarly, the control mode in which the shutter 68 is fixed to the optical path non-forming state, for example, fixed to the light blocking state regardless of the ON/OFF of the light source 65 is referred to as an optical path non-forming control mode or a third control mode.

For example, when the optical path forming control mode is used, the driver 6 can visually recognize the video light 32 as a virtual image, but on the other hand, the sunlight 31 may enter the video display 35. Also, when the optical path non-forming control mode is used, it is possible to prevent the sunlight 31 from entering the video display 35, but on the other hand, the driver 6 cannot visually recognize the video light 32 as a virtual image. Meanwhile, when the switching control mode is used, it is possible to suppress the sunlight 31 from entering the video display 35 while allowing the driver 6 to visually recognize the video light 32 as a virtual image.

Specifically, in the switching control mode, the shutter 68 can transmit all of the video light 32 emitted from the display panel 64 during the ON-period Ton. Also, the shutter 68 can block the sunlight 31 from entering the display panel 64 during the OFF-period Toff in which the video light 32 is not emitted from the display panel 64. As a result, since the period during which the sunlight 31 enters is limited to the ON-period Ton in the PWM cycle Tpwm, the temperature rise ΔT(I) due to the sunlight 31 shown in FIG. 7B can be suppressed. In this way, it is possible to reduce the time period during which the driver 6 cannot visually recognize the virtual image while preventing the damage to the video display 35, specifically, the display panel 64.

Note that there are the shutter 68 whose default state is the light transmission state and the shutter 68 whose default state is the light blocking state. When the default state of the shutter 68 is the light transmission state, the shutter 68 is controlled to the light blocking state by the application of the voltage Vf, and when the default state thereof is the light blocking state, the shutter 68 is controlled to the light transmission state by the application of the voltage Vf. The power consumption associated with controlling the shutter 68 can be reduced by using the shutter 68 whose default state is the light transmission state. Namely, in a general usage of the HUD apparatus 1, the period during which the shutter 68 is controlled to the light transmission state is longer than the period during which the shutter 68 is controlled to the light blocking state. Meanwhile, when the shutter 68 whose default state is the light blocking state is used, it is possible to prevent damage to the display panel 64 even if the shutter 68 becomes uncontrollable for some reason.

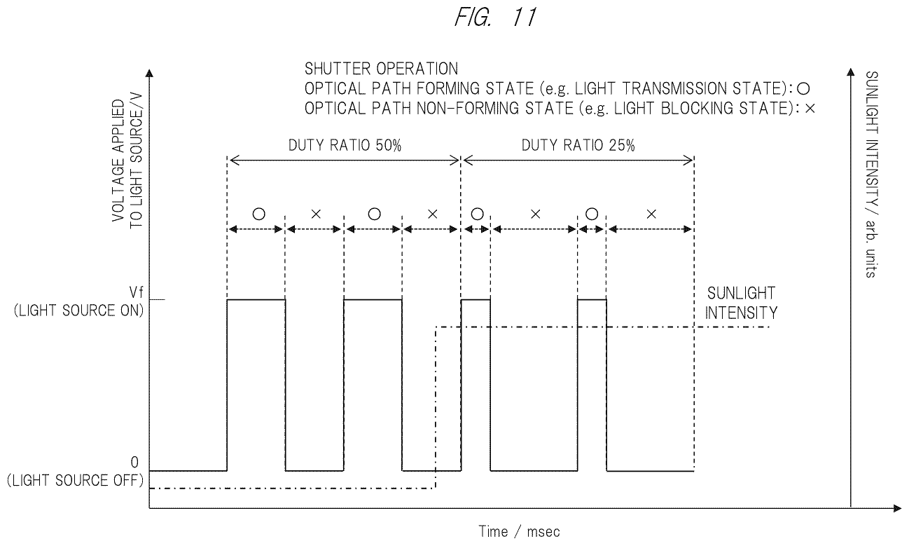

FIG. 11 is a time chart showing an example of a relationship between a control method of the light source and the shutter in FIG. 3 and the sunlight intensity. As shown in FIG. 11, when the sunlight intensity becomes strong, the controller 10 performs control to decrease the duty ratio of the PWM control for the light source 65. In this way, it is possible to suppress the temperature rise ΔT(L) due to the light source 65 and thus the temperature rise of the display panel 64.

Further, the controller 10 controls the shutter 68 in the switching control mode in conjunction with the PWM control of the light source 65. In this way, since the sunlight 31 can be blocked by the shutter 68 during the OFF-period Toff which becomes longer due to the decrease in the duty ratio, the temperature rise ΔT(I) due to the sunlight 31 and thus the temperature rise of the display panel 64 can be suppressed more. As described above, by controlling the ON/OFF of the light source 65 by the PWM control and controlling the shutter 68 to the optical path forming state and the optical path non-forming state in conjunction with the ON/OFF of the light source 65, it is possible to obtain a synergistic effect of suppressing the temperature rise of the display panel 64.

### <Modification of Switching Control Mode>

In FIG. 9, the switching control mode is used in conjunction with the ON/OFF of the light source 65, but it is also possible in some cases to use a method in which the shutter 68 is PWM controlled in a state where the display panel 64 always emits video light, that is, in a state where the light source 65 is always on. Even when such a method is used, the effect of suppressing the temperature rise ΔT(I) due to the sunlight 31 can be obtained. However, in this case, as compared with the case of the control in conjunction with the ON/OFF of the light source 65, the temperature rise ΔT(L) due to the light source 65 increases, and the power consumption of the light source 65 also increases. From such a point of view, it is beneficial to use the switching control mode in conjunction with the ON/OFF of the light source 65.

### <Details of Shutter Control Method>

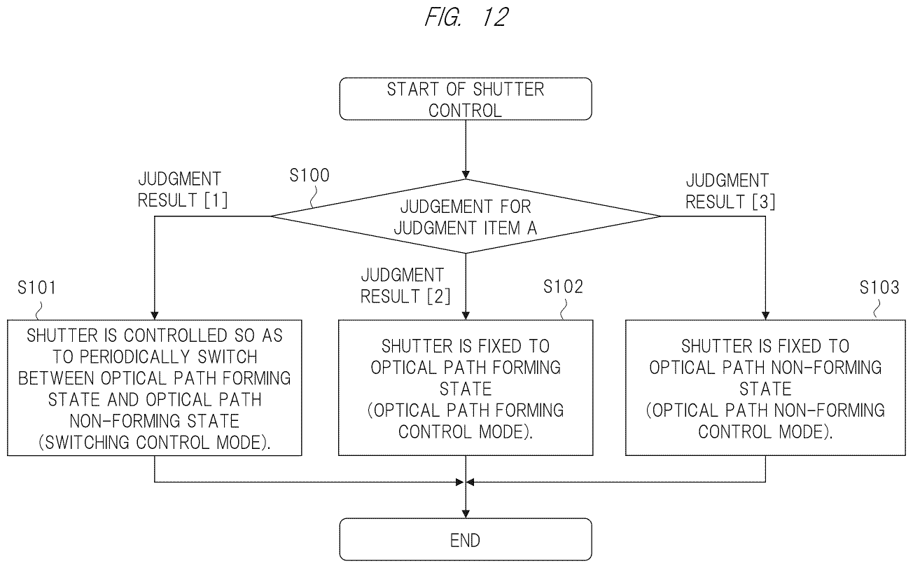

FIG. 12 is a flow diagram showing an example of process contents of the controller related to the control of the shutter in FIG. 5. The controller 10 repeatedly executes the flow shown in FIG. 12 at a predetermined control cycle. In FIG. 12, the controller 10 performs condition judgment for a judgment item A (step S100). When the judgment result in step S100 is [1], the controller 10 controls the shutter 68 in the switching control mode (step S101). Namely, the controller 10 controls the shutter 68 so as to periodically switch between the optical path forming state and the optical path non-forming state. Specifically, for example, the shutter 68 is controlled to the optical path forming state and the optical path non-forming state in conjunction with the ON/OFF of the light source 65.

On the other hand, when the judgment result in step S100 is [2], the controller 10 controls the shutter 68 in the optical path forming control mode (step S102). Namely, the controller 10 fixes the shutter 68 to the optical path forming state. Further, when the judgment result in step S100 is [3], the controller 10 controls the shutter 68 in the optical path non-forming control mode (step S103). Namely, the controller 10 fixes the shutter 68 to the optical path non-forming state.

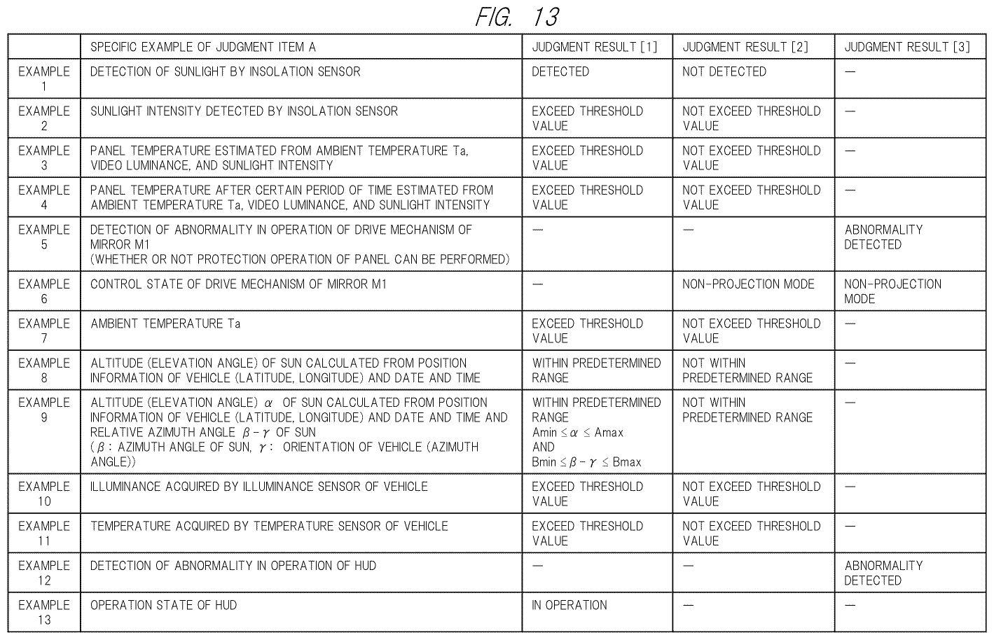

FIG. 13 is a diagram showing a specific example of the condition judgment (step S100) shown in FIG. 12. FIG. 14 is a supplementary diagram for FIG. 13 and is a diagram showing an example of a positional relationship between the sun and the vehicle. FIG. 13 shows examples 1 to 13 as specific examples of the condition judgment (step S100) in FIG. 12. In the examples 1 to 13, correspondence relationships between the judgment item A and the judgment results [1], [2], and [3] are shown.

In the example 1, the controller 10 judges whether or not the insolation sensor 66 detects the sunlight 31. Specifically, the controller 10 judges the substantial presence or absence of the sunlight 31 based on the detection result of the insolation sensor 66, for example, by using classifications such as day/night and sunny/cloudy. When the controller 10 judges that the sunlight 31 is detected, the judgment result is [1], and the shutter 68 is controlled in the switching control mode. When the controller 10 judges that the sunlight 31 is not detected, the judgment result is [2], and the shutter 68 is controlled in the optical path forming control mode. Note that the judgment result [3] is not used in the example 1.

In the example 2, the controller 10 judges whether or not the sunlight intensity detected by the insolation sensor 66 exceeds the threshold value. Specifically, for example, the controller 10 judges whether or not the sunlight intensity detected by the insolation sensor 66 is at a level that can cause damage to the display panel 64, based on the threshold value. Therefore, in the example 2, a relatively large threshold value is used. Alternatively, the controller 10 may judge whether or not the sunlight 31 is detected in the example 1 by using, for example, a sufficiently smaller threshold value than that in the example 2. Also, in the examples 1 and 2, the controller 10 may make judgments including the position of the sun 60 based on the configuration and arrangement of the insolation sensor 66 described with reference to FIG. 4.

When the sunlight intensity exceeds the threshold value, the judgment result is [1] and the controller 10 controls the shutter 68 in the switching control mode, and when the sunlight intensity does not exceed the threshold value, the judgment result is [2] and the controller 10 controls the shutter 68 in the optical path forming control mode. By using the switching control mode when the sunlight intensity exceeds the threshold value, it is possible to suppress the temperature rise ΔT(I) due to the sunlight 31. On the other hand, by using the optical path forming control mode when the sunlight intensity does not exceed the threshold value, the frequency of ON/OFF operations of the shutter 68 is reduced, so that the power consumption can be reduced and the wear of the shutter 68 can be suppressed. Note that the judgment result [3] is not used in the example 2.

In the example 3, the controller 10 judges whether or not the current estimated temperature of the display panel 64, which is estimated from the ambient temperature Ta, the temperature rise ΔT(L) in accordance with the video luminance, and the temperature rise ΔT(I) in accordance with the sunlight intensity, exceeds the threshold value. Namely, the controller 10 makes judgment based on the detection result of the temperature detector 15. When the current estimated temperature of the display panel 64 exceeds the threshold value, the judgment result is [1] and the controller 10 controls the shutter 68 in the switching control mode, and when the sunlight intensity does not exceed the threshold value, the judgment result is [2] and the controller 10 controls the shutter 68 in the optical path forming control mode. Note that the judgment result [3] is not used in the example 3.

In the example 4, unlike the case of the example 3, the controller 10 judges whether or not the temperature of the display panel 64 after a certain period of time, which is estimated from the ambient temperature Ta, the temperature rise ΔT(L) in accordance with the video luminance, and the temperature rise ΔT(I) in accordance with the sunlight intensity, exceeds the threshold value. Specifically, for example, the controller 10 estimates the temperature of the display panel 64 after a certain period of time by reflecting the rate of change of the temperature rises ΔT(L) and ΔT(I), transient characteristics, and the like, and applies the switching control mode at the present time when the estimated temperature exceeds the threshold value. In the example 3, when a rapid temperature rise occurs, the temperature of the display panel 64 may rise beyond expectations due to control delays. It is possible to cope with such a case by using the example 4.

In the example 5, the controller 10 judges whether or not an abnormality is detected in the drive mechanism 62 attached to the mirror M1. When it is judged that an abnormality is detected, the judgment result is [3] and the controller 10 controls the shutter 68 in the optical path non-forming control mode. Note that the judgment result [1] and the judgment result [2] are not used in the example 5. The case where an abnormality is detected is, for example, the case where an overcurrent, an overload, an overtemperature, or the like is detected in the drive mechanism 62 such as a motor. In this case, since the protection operation using the mirror M1, that is, the transition to the non-projection mode cannot be performed, it is possible to reliably prevent the display panel 64 from being damaged, by using the optical path non-forming control mode.

In the example 6, the controller 10 judges whether or not the control state of the mirror M1 is the non-projection mode. When the control state of the mirror M1 is the non-projection mode, the judgment result is [2] and the controller 10 controls the shutter 68 in the optical path forming control mode, or the judgment result is [3] and the controller 10 controls the shutter 68 in the optical path non-forming control mode. Since the shutter 68 is in a standby state and the sunlight 31 does not enter in the non-projection mode, the shutter 68 may be controlled in either the optical path forming control mode or the optical path non-forming control mode. Note that the judgment result [1] is not used in the example 6.

In the example 7, the controller 10 judges whether or not the ambient temperature Ta of the video display 35 exceeds the threshold value. When the ambient temperature Ta exceeds the threshold value, the judgment result is [1] and the controller 10 controls the shutter 68 in the switching control mode, and when it does not exceed the threshold value, the judgment result is [2] and the controller 10 controls the shutter 68 in the optical path forming control mode. When the ambient temperature Ta exceeds the threshold value, the permissible amount of the temperature rise ΔT(I) due to the sunlight 31 is reduced correspondingly. Therefore, the temperature rise ΔT(I) is suppressed to prevent the damage to the display panel 64 by using the switching control mode. Note that the judgment result [3] is not used in the example 7.

In the example 8, the controller 10 judges whether or not the altitude (in other words, the elevation angle) of the sun 60 calculated based on the position information of the vehicle 2 such as the latitude and longitude information and the information of the current date and time is within a predetermined range. The position information of the vehicle 2 and the information of the current date and time can be acquired from, for example, GPS information or the like included in the vehicle information 4. When the altitude of the sun 60 is within the predetermined range, the judgment result is [1] and the controller 10 controls the shutter 68 in the switching control mode, and when the altitude of the sun 60 is not within the predetermined range, the judgment result is [2] and the controller 10 controls the shutter 68 in the optical path forming control mode. The predetermined range is, for example, a relatively high altitude range and a range in which the sunlight intensity can be relatively strong. Note that the judgment result [3] is not used in the example 8.

In the example 9, the controller 10 judges whether or not the altitude (in other words, the elevation angle) “a” of the sun 60 and the relative azimuth angle “β-γ” of the sun 60 calculated based on the position information of the vehicle 2 such as the latitude and longitude information and the information of the current date and time are within predetermined ranges, respectively. “β” is the azimuth angle of the sun 60 and “γ” is the azimuth angle (in other words, orientation) of the vehicle 2. The relative azimuth angle “β-γ” of the sun 60 represents the azimuth angle of the sun 60 based on the orientation of the vehicle 2 as shown in FIG. 14. The azimuth angle “β” of the sun 60 is calculated based on the GPS information included in the vehicle information 4 such as the position information of the vehicle 2 and the information of the current date and time. The orientation “γ” of the vehicle 2 is calculated based on the acceleration gyro information, the GPS information, and the like included in the vehicle information 4.

When the altitude “α” of the sun 60 is within the predetermined range, that is, A min≤α≤A max is satisfied and the relative azimuth angle “β-γ” of the sun 60 is within the predetermined range, that is, B min≤β-γ≤B max is satisfied, the judgment result is [1] and the controller 10 controls the shutter 68 in the switching control mode. On the other hand, when the altitude “α” of the sun 60 is not within the predetermined range or the relative azimuth angle “β-γ” is not within the predetermined range, the judgment result is [2] and the controller 10 controls the shutter 68 in the optical path forming control mode. Note that the judgment result [3] is not used in the example 9.

Here, in the example 8, when the altitude of the sun 60 is within the predetermined range, it is judged that strong sunlight 31 may enter, and the switching control mode is used. As a result, the temperature rise ΔT(I) due to the sunlight 31 is suppressed. On the other hand, in the example 9, even when the altitude of the sun 60 is within the predetermined range, it is judged that the strong sunlight 31 does not enter if the vehicle 2 is oriented such that the sunlight 31 does not enter the display panel 64, and the optical path forming control mode is used instead of the switching control mode. As a result, as compared with the case of the example 8, the frequency of ON/OFF operations of the shutter 68 is reduced, so that the power consumption can be reduced and the wear of the shutter 68 can be suppressed. Note that the judgment result [3] is not used in the example 9.

In the example 10, the controller 10 judges whether or not the illuminance acquired from the illuminance sensor 45 of the vehicle 2 via the information acquisition unit 14 exceeds the threshold value. When the acquired illuminance exceeds the threshold value, the judgment result is [1] and the controller 10 controls the shutter 68 in the switching control mode, and when it does not exceed the threshold value, the judgment result is [2] and the controller 10 controls the shutter 68 in the optical path forming control mode. In the example 10, the sunlight intensity and the like are indirectly judged based on the detection result of the illuminance sensor 45. Then, when it is judged that the sunlight intensity and the like are strong, the controller 10 suppresses the temperature rise ΔT(I) due to the sunlight 31 by using the switching control mode. Note that the judgment result [3] is not used in the example 10.

In the example 11, the controller 10 judges whether or not the temperature acquired from the temperature sensor 52 of the vehicle 2 via the information acquisition unit 14 exceeds the threshold value. When the acquired temperature exceeds the threshold value, the judgment result is [1] and the controller 10 controls the shutter 68 in the switching control mode, and when it does not exceed the threshold value, the judgment result is [2] and the controller 10 controls the shutter 68 in the optical path forming control mode. In the example 11, the controller 10 detects or estimates the ambient temperature Ta and the like based on, for example, the temperature acquired from the temperature sensor 52, and controls the shutter 68 based on the result thereof. Note that the judgment result [3] is not used in the example 11.

In the example 12, the controller 10 judges whether or not an abnormality in the operation of the HUD apparatus 1 is detected. When it is judged that an abnormality is detected, the judgment result is [3] and the controller 10 controls the shutter 68 in the optical path non-forming control mode. For example, when an abnormality occurs in the video display 35 and strong video light 32 is emitted from the video display 35, driving by the driver 6 who visually recognizes the video light 32 may be hindered. In order to ensure safety even when an abnormality occurs in the HUD apparatus 1 as in the above-mentioned case described as a representative example, the optical path non-forming control mode is used when it is judged that an abnormality is detected. Note that the judgment result [1] and the judgment result [2] are not used in the example 12.

In the example 13, if the HUD apparatus 1 is in operation, the judgment result is [1] and the controller 10 controls the shutter 68 in the switching control mode. Namely, in the example 13, the optical path forming control mode and the optical path non-forming control mode are not used, and the switching control mode is always used. Even in this case, for example, it is possible to sufficiently prevent damage to the display panel 64 by controlling the duty ratio in accordance with the sunlight intensity to the light source 65 or by using the protection operation by the mirror M1 in combination.

Note that each judgment item A shown in the examples 1 to 12 can be used alone or in combination as appropriate.

### Various Application Examples of Shutter

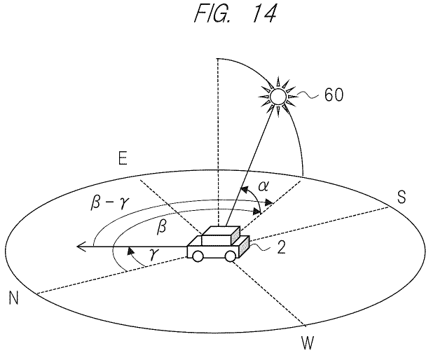

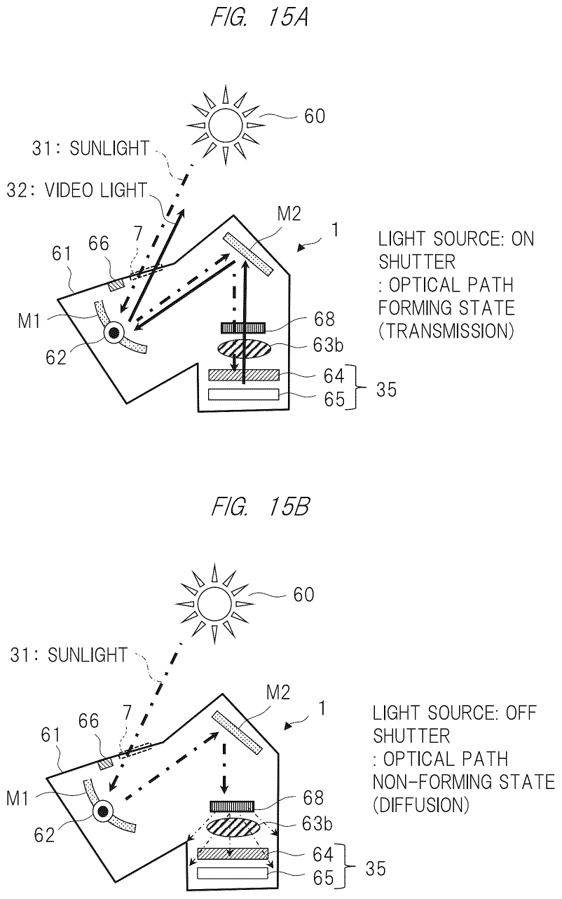

FIG. 15A and FIG. 15B are diagrams for describing another specific application example of the shutter in FIG. 3 and an operation example at that time. The shutter 68 shown in FIG. 15A and FIG. 15B is, for example, a transmission/diffusion liquid crystal shutter. As shown in FIG. 15A, during the ON-period Ton of the light source 65, the shutter 68 is controlled to the optical path forming state to transmit the light as in the case of FIG. 10A.

On the other hand, as shown in FIG. 15B, the shutter 68 is controlled to the optical path non-forming state during the OFF-period Toff of the light source 65 to diffuse the light unlike the case of FIG. 10B. Namely, the shutter 68 blocks the sunlight 31 from entering the display panel 64 by diffusing the sunlight 31. In this case, a part of the diffused sunlight 31 may enter the display panel 64, but the incident energy thereof is small and thus the sunlight 31 is substantially blocked.

The installation position of the shutter 68 is not limited to the position between the optical element 63b and the mirror M2 shown in FIG. 15A and FIG. 15B, and can be changed as appropriate as in the case of FIG. 10A and FIG. 10B. Namely, the installation position of the shutter 68 may be the position between the video display 35 and the optical element 63b, the position between the mirror (video light reflector) M2 and the mirror (video light projector) M1, a position at the opening 7, or the like. In addition, the shutter 68 may be installed in contact with the reflection surface of the mirror M2.

However, when the installation position of the shutter 68 is too close to the display panel 64, for example, when it is installed between the video display 35 and the optical element 63b, the diffused sunlight 31 is likely to enter the display panel 64. From this point of view, the shutter 68 is desirably installed at the position shown in FIG. 15A and FIG. 15B. Also, the sunlight diffused by the shutter 68 may become stray light and reach the eyes of the driver 6 after being emitted from the opening 7. For this reason, it is desirable that a wall-shaped light shielding component or the like is provided around the shutter 68.

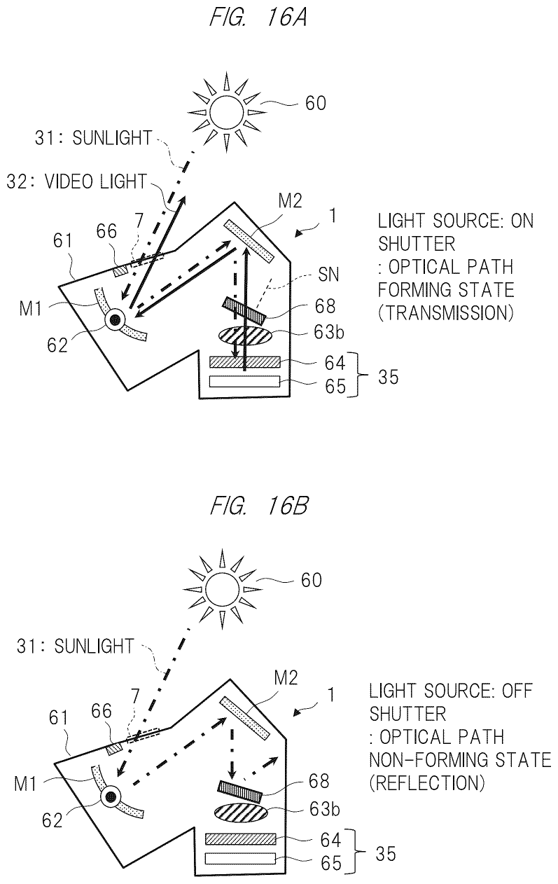

FIG. 16A and FIG. 16B are diagrams for describing still another specific application example of the shutter in FIG. 3 and an operation example at that time. The shutter 68 shown in FIG. 16A and FIG. 16B is, for example, a MEMS (Micro Electro Mechanical Systems) shutter. As shown in FIG. 16A, during the ON-period Ton of the light source 65, the shutter 68 is controlled to the optical path forming state to transmit the light as in the case of FIG. 10A. On the other hand, as shown in FIG. 16B, during the OFF-period Toff of the light source 65, the shutter 68 is controlled to the optical path non-forming state to reflect the light unlike the case of FIG. 10B. Namely, the shutter 68 blocks the sunlight 31 from entering the display panel 64 by reflecting the sunlight 31.

Here, in FIG. 16B, unlike the case of FIG. 10B, the sunlight 31 reflected by the shutter 68 may reach the eyes of the driver 6 after being emitted from the opening 7 through the optical path opposite to the optical path of the entering light. Therefore, the shutter 68 is desirably installed as shown in FIG. 16A and FIG. 16B such that the reflected light is not directed to the mirror M2. Specifically, the shutter 68 is desirably installed such that the surface normal SN of the shutter 68 and the optical axis of the video light 32 intersect. In addition, it is desirable that the portion of the housing 61 exposed to the reflected light is made of a highly heat-resistant material or a highly heat-dissipating material. Alternatively, heat radiation fins or the like may be installed at the portion exposed to the reflected light.

The installation position of the shutter 68 is not limited to the position between the optical element 63b and the mirror M2 shown in FIG. 16A and FIG. 16B, and can be changed as appropriate as in the case of FIG. 10A and FIG. 10B. In this case, even if the shutter 68 is installed near the display panel 64, the problem due to heat released to the display panel 64 as in the case of FIG. 10B and the problem of diffused light entering the display panel 64 as in the case of FIG. 15B do not occur. On the other hand, it is desirable that the position between the mirror (video light projector) M1 and the display region 5, for example, the position of the opening 7 is excluded from the installation position of the shutter 68 such that the reflected light does not reach the eyes of the driver 6.

### Main Effects of First Embodiment

As described above, in the HUD apparatus 1 according to the first embodiment, a switching unit, for example, the shutter 68 is provided on the optical path of the video light 32, and the shutter 68 is controlled so as to periodically switch between the optical path forming state and the optical path non-forming state. In this way, it is possible to reduce the time period during which the user cannot visually recognize the virtual image while preventing the damage to the display panel 64 due to the sunlight 31. Further, in addition to the switching control mode, the optical path forming control mode and the optical path non-forming control mode are provided, and the optical path forming control mode and the optical path non-forming control mode can be selected in accordance with various conditions, whereby unnecessary ON/OFF operations of the shutter can be eliminated. Also, by combining with the protection operation using the mirror (video light projector) M1, it becomes possible to prevent damage to the display panel 64 more reliably.

### Second Embodiment

### Application Example of Shutter

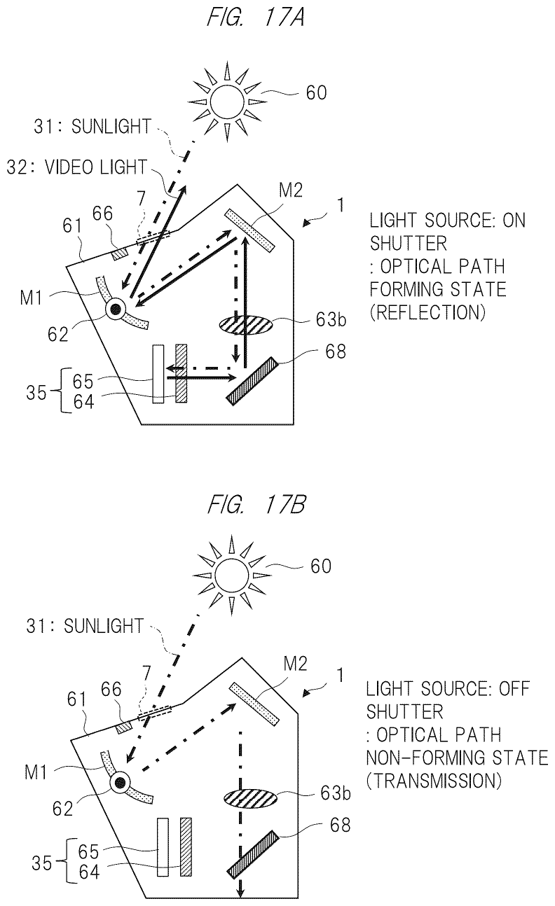

FIG. 17A and FIG. 17B are diagrams for describing a specific application example of the shutter in the HUD apparatus according to the second embodiment and an operation example at that time. The shutter 68 shown in FIG. 17A and FIG. 17B is, for example, a transmission/reflection MEMS shutter as in the case of FIG. 16A and FIG. 16B. However, in FIG. 17A and FIG. 17B, the video display 35 and the shutter 68 are arranged such that the shutter 68 reflects the video light from the video display 35 to the mirror M2.

With this configuration, as shown in FIG. 17A, the shutter 68 reflects the light instead of transmitting it during the ON-period Ton of the light source 65, that is, in the optical path forming state unlike the case of FIG. 16A. Specifically, the shutter 68 reflects the video light 32 from the video display 35 to the mirror M2 and reflects the sunlight 31 from the mirror M2 to the video display 35.

On the other hand, as shown in FIG. 17B, the shutter 68 transmits the light instead of reflecting it during the OFF-period Toff of the light source 65, that is, in the optical path non-forming state unlike the case of FIG. 16B. The shutter 68 blocks the sunlight 31 from entering the display panel 64 by transmitting the sunlight 31. It is desirable that the portion of the housing 61 exposed to the transmission light is made of a highly heat-resistant material or a highly heat-dissipating material. Alternatively, heat radiation fins or the like may be installed at the portion exposed to the transmission light.

Note that FIG. 17A and FIG. 17B show an example in which the shutter 68 is separately installed, but as another modification using the reflection characteristics of the shutter 68, for example, the mirror M2 may be replaced with a MEMS shutter in FIG. 10A and FIG. 10B. In this case, the MEMS shutter reflects the light during the ON-period Ton of the light source 65, that is, in the optical path forming state, and thus the optical path similar to that in the case of FIG. 10A is formed. On the other hand, the MEMS shutter transmits the light during the OFF-period Toff of the light source 65, that is, in the optical path non-forming state, and the optical path in which the mirror M2 transmits the sunlight 31 is formed in FIG. 10B.

As described above, by using the HUD apparatus 1 according to the second embodiment, the same various effects as those described in the first embodiment can also be obtained.

In the foregoing, the invention made by the inventor of this application has been specifically described based the embodiments, but the present invention is not limited to the embodiments described above and can be modified in various ways within the range not departing from the gist thereof. For example, the embodiments above have been described in detail in order to make the present invention easily understood, and the present invention is not necessarily limited to the embodiments having all of the described configurations. Also, a part of the configuration of one embodiment may be replaced with the configuration of another embodiment, and the configuration of one embodiment may be added to the configuration of another embodiment. Furthermore, another configuration may be added to a part of the configuration of each embodiment, and a part of the configuration of each embodiment may be eliminated or replaced with another configuration.

For example, by using the technique according to the embodiment, as described above, it is possible to reduce the time period during which the user cannot visually recognize the virtual image while preventing the damage to the display panel due to the sunlight. In addition, it is possible to provide the information display apparatus (head up display apparatus) capable of visually recognizing the video of information necessary for driving such as the alert information when oncoming vehicles or pedestrians are detected in addition to the navigation information display such as the destination and speed projected on the windshield and contributing to the assistance of the safety driving by reducing the movement of the viewpoint of the driver. In this way, it is possible to prevent traffic accidents. Further, it is possible to contribute to “Goal 3: Ensure healthy lives and promote well-being for all at all ages” in the Sustainable Development Goals (SDGs) advocated by the United Nations.

### REFERENCE SIGNS LIST

1 head up display (HUD) apparatus
2 vehicle
4 vehicle information
5 display region
6 driver (user)
10 controller
14 information acquisition unit
15 temperature detector
30 optical path of video light
32 video light
35 video display
60 sun
62 drive mechanism
64 display panel
65 light source
68 shutter
M1 mirror (video light projector)
M2 mirror (video light reflector)
SN surface normal

1. A head up display apparatus for a transportation, the head up display apparatus comprising:
a video display configured to generate and emit video light of a video;
a video light projector configured to project the video light emitted from the video display to a display region of the transportation so as to be reflected, thereby displaying a virtual image in front of the transportation; and
a switching unit provided on an optical path of the video light and configured to switch to an optical path forming state in which the optical path of the video light is formed or an optical path non-forming state in which the optical path of the video light is not formed,
wherein a length of time when the switching unit is switched to the optical path non-forming state is a length of time in which the video light can be continuously visually recognized as the virtual image.

2. The head up display apparatus according to claim 1, further comprising a video light reflector provided on the optical path of the video light between the video display and the video light projector and configured to reflect the video light from the video display to the video light projector.

3. The head up display apparatus according to claim 2,
wherein the switching unit is provided on the optical path of the video light between the video display and the video light reflector.

4. The head up display apparatus according to claim 2,
wherein the switching unit is provided on the optical path of the video light between the video light reflector and the video light projector.

5. The head up display apparatus according to claim 1,
wherein the switching unit transmits light in the optical path forming state and absorbs or diffuses light in the optical path non-forming state.

6. The head up display apparatus according to claim 1,
wherein the switching unit transmits light in the optical path forming state and reflects light in the optical path non-forming state, and
wherein the switching unit is installed such that a surface normal of the switching unit and an optical axis of the video light intersect.

7. The head up display apparatus according to claim 1,
wherein the switching unit reflects light in the optical path forming state and transmits light in the optical path non-forming state.

8. The head up display apparatus according to claim 1, further comprising a controller configured to control the video display and the switching unit.

9. The head up display apparatus according to claim 8,
wherein the controller controls the switching unit so as to switch between the optical path forming state and the optical path non-forming state.

10. The head up display apparatus according to claim 8,
wherein the controller controls the switching unit so as to periodically switch between the optical path forming state and the optical path non-forming state.

11. The head up display apparatus according to claim 10,
wherein the video display includes:
a light source configured to turn on backlight when it is controlled on and turn off the backlight when it is controlled off; and
a display panel configured to display the video by modulating the backlight from the light source, and
wherein the controller controls ON/OFF of the light source by PWM control and controls the switching unit to the optical path forming state and the optical path non-forming state in conjunction with the ON/OFF of the light source.

12. The head up display apparatus according to claim 10,
wherein the controller performs a condition judgment and controls the switching unit by using a first control mode in which the switching unit periodically switches between the optical path forming state and the optical path non-forming state or a second control mode in which the switching unit is fixed to the optical path forming state, based on a judgment result of the condition judgment.

13. The head up display apparatus according to claim 12, further comprising a temperature detector configured to detect a temperature of the video display,
wherein the controller controls the switching unit by using the first control mode when the temperature detected by the temperature detector exceeds a threshold value and controls the switching unit by using the second control mode when the temperature detected by the temperature detector does not exceed the threshold value.

14. The head up display apparatus according to claim 12,
wherein the controller calculates an altitude of sun based on position information of the transportation and information of a current date and time, and controls the switching unit by using the first control mode when the calculated altitude of the sun is within a predetermined range and controls the switching unit by using the second control mode when the calculated altitude of the sun is not within the predetermined range.

15. The head up display apparatus according to claim 12,
wherein the controller further controls the video light projector,
wherein the video light projector includes:
a mirror configured to reflect the video light to the display region; and
a drive mechanism configured to adjust an installation angle of the mirror, and
wherein the controller controls the video light projector to a non-projection mode in which the video light is not projected to the display region or a projection mode in which the video light is projected to the display region, by adjusting the installation angle of the mirror via the drive mechanism.

16. The head up display apparatus according to claim 15,
wherein the controller controls the switching unit by using a third control mode in which the switching unit is fixed to the optical path non-forming state when an abnormality in an operation of the drive mechanism is detected.

17. A control method of a head up display apparatus installed in a transportation, the control method comprising:
acquiring information related to the transportation;
displaying a video representing the acquired information related to the transportation and emitting video light of the displayed video;
projecting the emitted video light to a display region, thereby causing a user to visually recognize the projected video light as a virtual image;
controlling an optical path of the video light by using a switching unit provided on the optical path of the video light and controlled to an optical path forming state in which the optical path of the video light is formed or an optical path non-forming state in which the optical path of the video light is not formed; and
controlling the switching unit so as to switch to a first control mode in which the switching unit periodically switches between the optical path forming state and the optical path non-forming state, a second control mode in which the switching unit is fixed to the optical path forming state, or a third control mode in which the switching unit is fixed to the optical path non-forming state, when controlling the optical path of the video light.
